(19) United States
(12) Patent Application Publication
(10) Pub. No.: US 2017/0124646 A1
(43) Pub. Date: May 4, 2017

(54) METHOD AND SYSTEM FOR TRADING ARTICLE

(71) Applicant: iishare corporation, San Jose, CA (US)

(72) Inventor: LI-MING HU, Taipei City (TW)

(21) Appl. No.: 14/925,856

(22) Filed: Oct. 28, 2015

(51) Int. Cl. G06Q 40/04

(52) U.S. Cl. CPC G06Q 40/04

(57) ABSTRACT

The disclosure is related to a system and a method for trading article between a buyer and a seller. In the system, a trading server is provided for conducting the transaction. The trading server has the articles registered by a plurality of sellers who may be located in fixed place or in moving. The system therefore allows the seller who can be anywhere to sell his goods if the buyer's request is matched. When the trading server receives the tags relating to an interested goods formed in a mobile device used by the buyer, a matching process is performed to establish an article list based on the matching result using the records in a database. When the trading server receives a selection made by the buyer based on the list, an order is established after confirming the order with the matched seller.

### BACKGROUND OF THE INVENTION

1. Field of the Invention

The present invention is generally related to a method and a system for trading article, in particular, to a method and a system for facilitating transaction between a buyer and a seller based on a location in interest.

2. Description of Related Art

Merchants or sellers today essentially utilize some schemes to advertise their goods over Internet, for example using a banner advertisement on a portal web page. Generally, the sellers are required to register their accounts to a specific web site and they are allowed to show the goods to be sold via the platform. For the buyers, they can get on the web site to pick up the goods provided by the registered sellers when they select the interested articles as browsing the on-line stores over the platform.

The conventional platform provides an interface allowing the sellers to upload their goods as well as the buyers to browse the goods. However, the buyers may themselves filter out the interested articles based on the sellers' locations when the buyers pick the articles up to a shopping cart.

To draw customers to the sellers' on-line stores, the merchants or sellers often pay the money for advertising their merchandise for attracting the interested customers to their sites. However, the advertisement may still fail to bring the buyers potentially interested in buying their goods because the sellers' locations are too far away from the potential buyers that is inconvenient for some buyers to reach the sellers' locations rather than by express delivery.

More, the conventional aspect of the on-line transaction is restricted to some specific on-line store service providers who rent the space to the merchants and the sellers, it is not friendly for the buyers who want to get the articles instantly.

### SUMMARY OF THE INVENTION

The disclosure is related to establishing a system to conduct trading of an article between a buyer and a non-specified seller, and to a method thereof. According to one aspect of the invention, the buyer or the deliverer can recognize the seller's location from the positioning information sent by the seller's mobile device when the transaction is done.

In one embodiment of the present invention, the invention is directed to a method for trading an article between a buyer and a seller using the service through a trading server. In the trading server where collects various articles submitted by the sellers allowing the any buyer to conduct an order, an interface is provided to receive tags relating to an interested goods made by a mobile device used by the buyer. While the articles registered in the trading server are associated with tags used to facilitate categorization, the software-implemented interface matches the tags with a plurality of records in a database of the trading server. It is noted that the records in the database are related to a plurality of tags related to a plurality of articles which are provided by at least one seller. Then, in the trading server, an article list is formed according to a matching policy when the trading server performs matching the tags with the records. The article list is transmitted to the buyer. When the buyer receives this list, he can make a selection associated with a matched article and a matched seller and send the selection to the trading server.

After that, in the trading server, an order is established after confirming the order with the matched seller. The requisite information is notified to both the buyer and the seller, and then the trading is completed.

It is noted that the mobile device of the buyer is installed with a software program which is used to form buying information made by the buyer, and also to process the buying information and extract features of the interested goods according to the buying information. Also, in an exemplary embodiment, the software program is used to form the tags relating to the features of the interested goods, and transmit the tags to the trading server.

When the trading is preliminarily completed, in the trading server, both the location information associated with the mobile device and location of the seller are transmitted to a deliverer who is going to pick up the interested article from the seller, and to deliver the matched article to the buyer.

According to one further aspect of the present invention, a system for trading an article between a buyer and a seller is provided. The system includes a trading server, which includes a data receiving unit, used to receive buying information made by the buyer, including tags relating to an interested goods formed in a mobile device used by the buyer, and information of at least one seller and at least one article from every seller; wherein the data receiving unit is also used to receive a selection made by the buyer; a data processing unit, used to process the information of the at least one seller and the at least one article for extracting features of the at least one article and forming one or more tags relating to every article; wherein the information of the at least one seller, the at least one article, and the one or more tags relating to every article are saved to a database; a memory unit, used to save the buying information and the one or more tags relating the interested goods transmitted by the buyer; a matching unit, used to retrieve the buying information and the one or more tags relating the interested goods from the memory unit, and match the tags with a plurality of records in the database of the trading server, so as to form an article list according to a matching policy; and an output unit, used to transmit the article list to the buyer.

In the system, a computer-readable storage device in the mobile device is provided for storing instructions for trading the article to perform steps such as forming the buying information including the interested goods; processing the buying information for extracting features of the interested goods; forming one or more tags relating to the interested goods; uploading the one or more tags to the trading server; receiving the article list; and transmitting the selection, made by the buyer, associated with a matched article and a matched seller based on the article list.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram depicting a circumstance using a mobile device to be a medium to complete a trade according to an aspect of the present invention;

FIG. 2 shows a schematic diagram depicting a navigation route using an electronic map displayed on a mobile device according to an aspect of the present invention;

FIG. 3 shows an example of a framework of system for trading article according to one embodiment of the present invention;

FIG. 4 shows an exemplary block diagram depicting a trading server according to one embodiment of the present invention;

FIG. 5 shows a flow chart illustrating a process to conduct trading between a buyer and a seller in one embodiment of the present invention;

FIG. 6 shows a flow chart illustrating a process allowing the seller to register data in the trading server according to one embodiment of the present invention;

FIG. 7 shows one more flow chart illustrating a process allowing the seller to use image of article to register data in the trading server according to one further embodiment of the present invention;

FIG. 8 shows a flow chart illustrating a process allowing the buyer to upload an interested goods to the trading server according to one embodiment of the present invention;

FIG. 9 shows a flow chart illustrating a process to conduct trading between a buyer and a seller according to one further embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

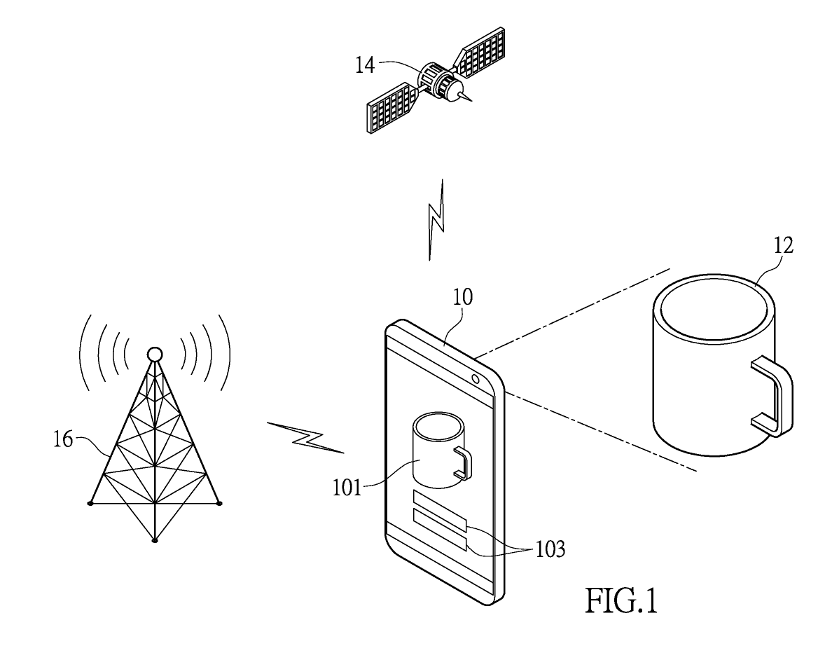

According to one aspect of the present invention, a trading system is provided for both the buyers and sellers or merchants to facilitate a transaction, especially in one exemplary embodiment to complete the trading through the both sides' mobile devices installed with the specific software program. FIG. 1 shows a schematic diagram depicting a circumstance using a mobile device to be a medium to complete a trade according to one aspect of the present invention. In this figure, a mobile device 10 used by the buyer or the seller is shown.

In an exemplary example, the mobile device 10 may be in the seller's hand, and used to capture an image of article 101 from an article 12 to be sold. When a software application, e.g. an APP generally used in the mobile device, is executed by a processor of the mobile device, an interface can be initiated to prompt the user to take a picture of the article 12 for creating the image 101, and also allow the user to add some descriptions of article 103. The mobile device 10 is generally a communication device capable of connecting with a satellite 14 for acquiring its positioning information, and a base station 16 for use of data transmission.

When the seller uses the mobile device 10 to create the image and descriptions related to the article 12, the software program allows the seller to upload the image and the related information to the trading server (not shown in this diagram), for example through the base station 16. Further, the positioning information or any input address information may be associated with the data of the article 12 that is transmitted to the trading server. In the trading server, the software-based function modules can extract features from the image of the article to be sold, and form tags related to the article for use of categorization of the articles in the trading server, and any user's search.

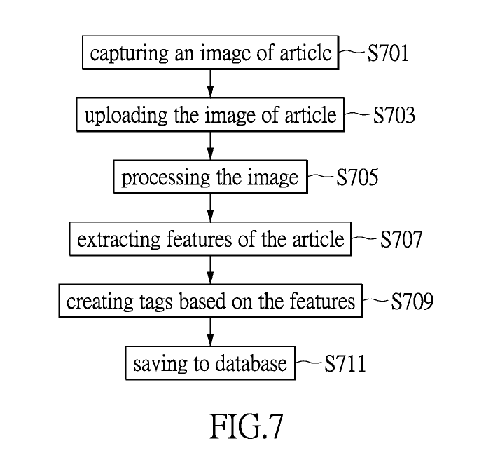

To use the image of article to facilitate the registration in the trading server, reference is made to FIG. 7 showing the flow chart illustrating a process allowing the seller to use image of article to register data in the trading server.

In this exemplary example, such as step S701, the software program executed in the seller-end device allows generating the article data by capturing an image of the article. When the image of article is uploaded to the trading server, such as in step S703, the software-based function of the trading server processes the image, such as in step S705, and extracts features of the article, such as in step S707. Then, as in step S709, the tags based on the features are created, and as in step S711 saved to the database of the server.

The mobile device 10 shown in the schematic diagram of FIG. 1 can also be adapted to the buyer. When the buyer wants to buy an article, he can turn on his mobile device and initiate a software program to get on Internet for searching the interested goods. According to one embodiment of the present invention, the software program allows the buyer to upload the information about his interested goods. In an exemplary example, the instructions in the software program for trading the article executed in the mobile device 10 drives a camera module to take a picture from a same or similar article with the interested goods. The software program can extract features from the image of the article and form the related tags as performing an image processing upon the image. The tags can be submitted to the trading server to be the reference for searching the records in the database in the server. The trading server then provides a search result for the buyer to choose the interested goods.

It is worth noting that the mobile device 10 in the buyer's hand may also transmit the positioning information to the trading server. The trading server may provide the search result based on the location of the buyer for facilitating the transaction. Further, the positioning information from the both seller and the buyer may be submitted to the deliverer to pick up the goods and deliver to the buyer.

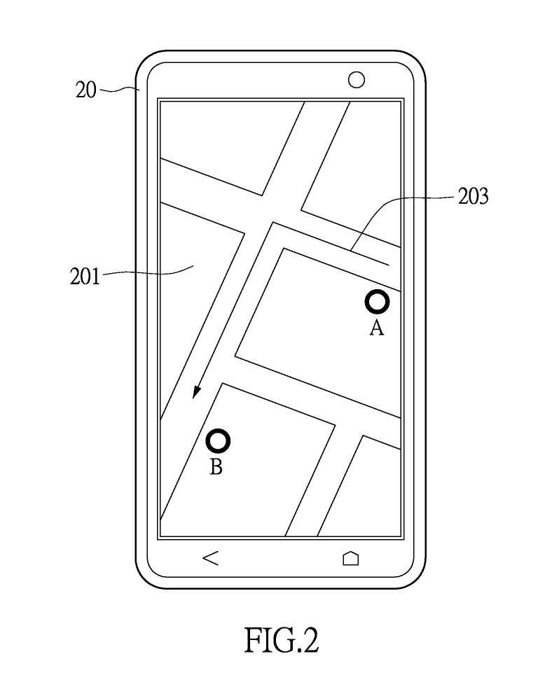

FIG. 2 shows a schematic diagram depicting a navigation route using an electronic map displayed on a mobile device according to an aspect of the present invention.

In FIG. 2, an electronic map 201 is shown on a screen of a mobile device 20. According to the aspect of the present invention, the buyer may select one matched article and one matched seller from an article list provided by the trading server when the trading server conducts a matching process based on the searching requirement made by the buyer. The software-based function of the trading server or the software program installed in the mobile device used by the buyer can generate a navigation route 203 between the buyer's location, for example the location A, and the seller's location, e.g. the location B, shown on the electronic map 201 according to the positioning information submitted by the both sides. The navigation route 203 is convenient for the both sides the find the way to deliver the matched article.

In one further embodiment, by the trading server, the navigation route 203 may also be given to a deliverer who picks up the matched article from the matched seller and delivers it to the buyer.

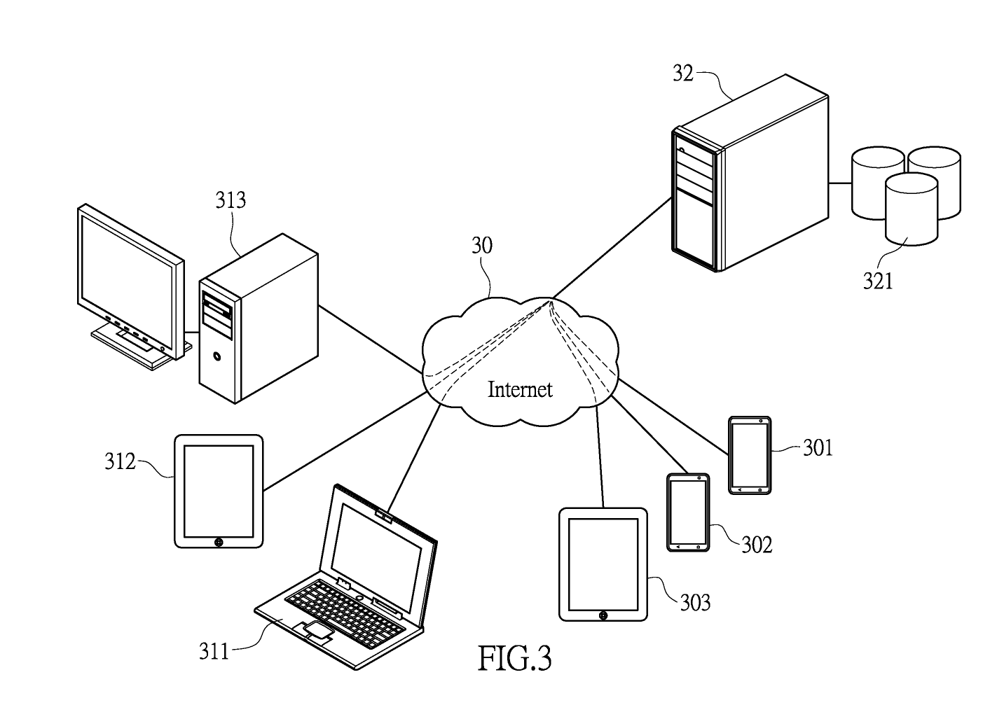

The framework of the trading system in accordance with the present invention may be referred to the schematic diagram shown in FIG. 3.

The trading system is essentially constituted of a trading server or system having database to render the transactions among people, a plurality of buyers using the buyer-end devices 301, 302, 303 who may be required to register the service provided by the trading server 32, and a plurality of sellers using the seller-end devices 311, 312, 313 who may be required to be members in the service of the trading server 32.

In the diagram of FIG. 3, the parties are connection over Internet 30, and the trading server 32 manages the essential data delivered among the parties. Any of the buyer-end devices 301, 302, 303 is installed with a specific software program, e.g. APP for the mobile device, adapted to the service made by the trading server 32; similarly some types of the seller-end devices 311, 312, 313 are applicable to the trading system, for example the seller can use the desktop computer (313), the mobile device (312), the laptop computer (311), or the like.

A database 321 of the trading server 32 is provided for this system to manage the data collected from both the sellers and the buyers, and the records in the database 321 are such as user registration data including user preference and historical records, articles with the tags to be sold, and the information for operation of the server.

In an exemplary example, a seller uses a computer such as one of the seller-end devices 311, 312, 313 to upload one article to be sold to the trading server 32. The data related to the article can be recorded in the database 321. The data related to the article includes tags analyzed by a software-implemented analysis tool of the trading server when the features of the article can be extracted and analyzed. It is noted that the trading server acknowledges the location of the seller according to the input of the seller or the positioning information generated by his mobile device. The system allows the buyer to use his mobile device such as one of the buyer-end devices 301, 302, 303 to make a search. The software program executed in the buyer's mobile device initiates an interface for the buyer to input the keywords or description related to the interested article. In the mobile device, the software program is used to form the tags relating to the features of the interested goods, and transmit the tags to the trading server so as to process the searching in the trading server 32.

The trading server 32 then forms an article list according to a matching policy when the trading server performs matching the tags with the records in the database 321. The article list is transmitted to the buyer for the further selection to get the matched article. When the trading server successfully facilitates the transaction after conducting the matching and confirming an order there-between.

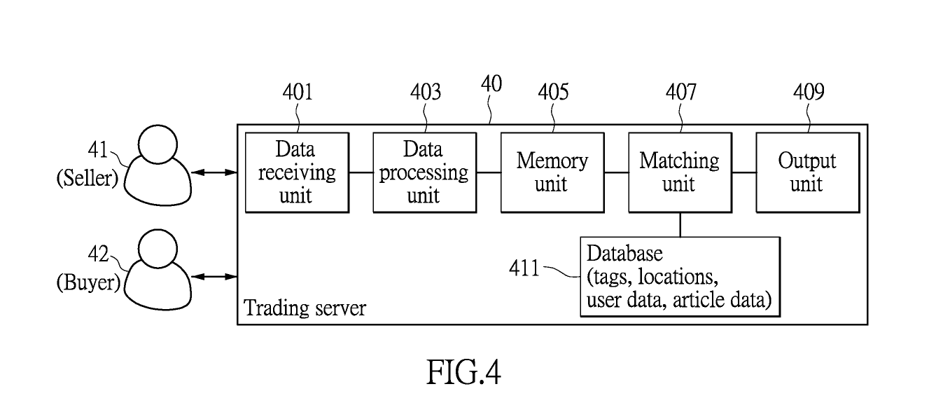

The block diagram exemplarily shown in FIG. 4 depicts the trading server according to one embodiment of the present invention.

The trading system in accordance with the present invention incorporates a trading server 40 to facilitate transaction between a seller 41 and a buyer 42. The trading server 40 is implemented by a server host or a cluster of computer systems. The functionalities provided by the trading server 40 are essentially embodied by a data receiving unit 401, a data processing unit 403, a memory unit 405, a matching unit 407, and an output unit 409. The trading server 40 may have its internal database 411 which records the user data and user's location information, and the article data with the tags. The database 411 may also be an external/cloud database located away from the server 40.

The data receiving unit 401 of the trading server 40 is used to receive buying information made by the buyer 42, including tags relating to an interested goods formed in a mobile device used by the buyer 42, and information of at least one seller 41 and at least one article from every seller 41. The data receiving unit 401 is also used to receive a selection made by the buyer 42, and transmit the article list to the buyer 42 as the matching process made by the trading server 40.

The data processing unit 403 of the trading server 40 is used to process the information of the at least one seller 41 and the at least one article for extracting features of the at least one article and forming one or more tags relating to every article. It is noted that the information of the at least one seller 41, the at least one article, and the one or more tags relating to every article are saved to the database 411.

The memory unit 405 of the trading server 40 can be a buffer memory for the operation of the server 40. The memory unit 40 can be used to save the buying information and the one or more tags relating the interested goods transmitted by the buyer 42.

The matching unit 407 of the trading server 40 is used to retrieve the buying information and the one or more tags relating the interested goods from the memory unit 405, and conduct matching of the tags with a plurality of records in the database 411 of the trading server 40. The matching process including matching the tags with a plurality of records in a database 411 of the trading server 40, and the records in the database 411 are related to a plurality of tags related to a plurality of articles which are provided by at least one seller 41. An article list according to a matching policy is therefore formed. The records in the database 411 are related to at least the plurality of tags of the plurality of articles which are provided by the at least one seller 41.

The trading server 40 uses the output unit 409 to be a communication interface used to communicated with both the seller 41 and the buyer 42, including transmitting the article list to the buyer 42 and transmitting the buyer information and the order to the seller 41.

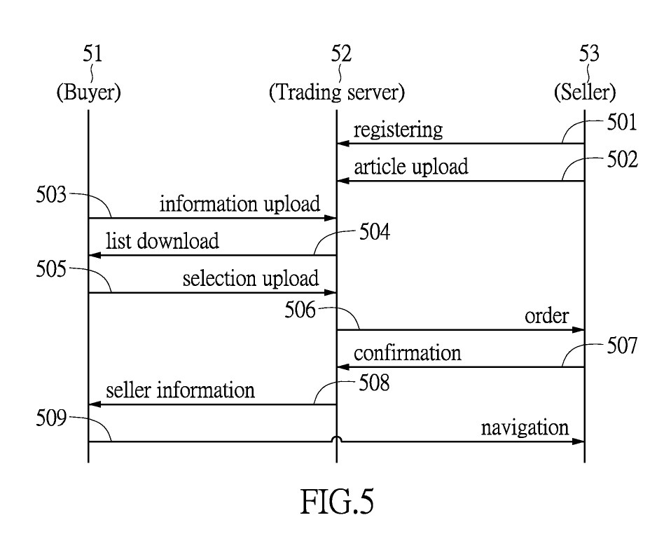

Furthermore, in the trading system in accordance with the present invention, a computer-readable storage device in the mobile device storing instructions for trading the article to perform the steps of transaction between the seller 41 and the buyer 42 is included. In one embodiment, the steps of transaction performed among the seller, the buyer, and the trading server are described in the flow chart shown in FIG. 5.

The diagram shows a flow chart describing the trading steps among the buyer 51, the trading server 52, and the seller 53. In the beginning, the trading server 52 accepts the registration request made by the seller 53 using a seller-end device. In step 501, the seller 53 conducts a registration to the trading server 52. In step 502, the seller 53 uploads data relating to at least one article to be exhibited or sold. The database of the trading server 52 has collected the records including the article data and the tags, the user data and the location, etc. Furthermore, in the database, a matching policy can be recorded, and the matching policy may include setting a tag threshold of number of tags to determine if there is at least one matched article, and/or setting a location threshold with a specific range of location to determine if there is at least one matched article.

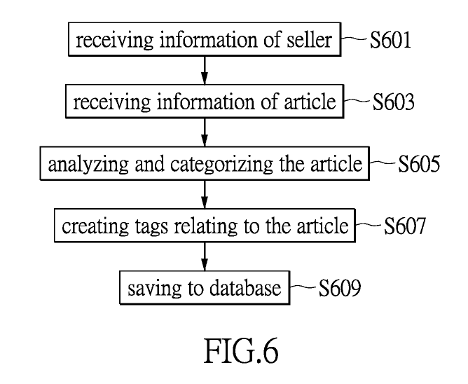

The process shown in FIG. 5 is further in view of the flow chart depicting the process between the seller-end device, e.g. the seller 53, and the trading server 52 shown in FIG. 6. In step S601, the trading server 52 initiates an interface to receive information of seller 53. In step S603, the trading server 52 also receives information of the article, and, in step S605, analyzes and categorizes the article so as to extract features of the article. From the features of the article, such as in step S607, a plurality of tags relating to the article can be generated and recorded to the database of the trading server 52, such as in step S609.

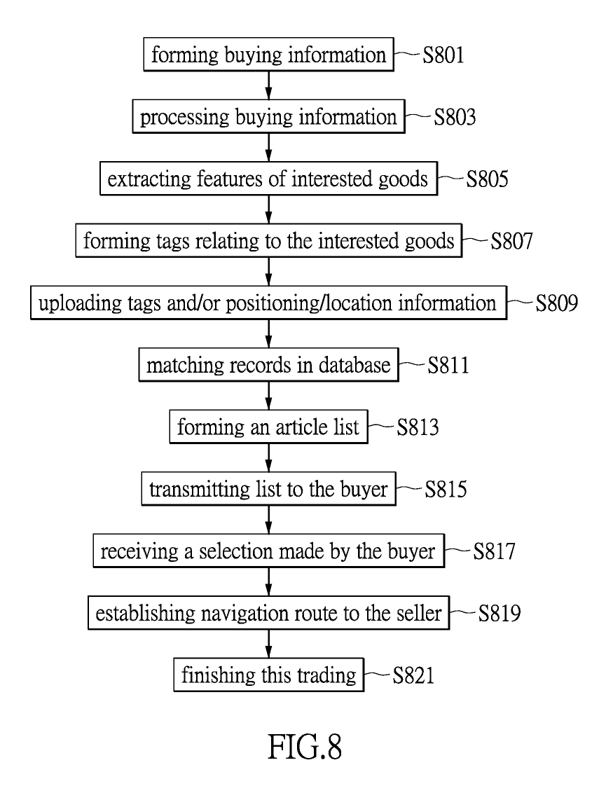

In the buyer-end mobile device used by the buyer 51, such as step 503 of FIG. 5, further in view of the steps depicted in FIG. 8, the buying information including at least one interested goods is formed (step S801 of FIG. 8). For example, an APP executed by the processor of the mobile device in the buyer's hand initiates an interface for prompting the buyer 51 to generate the buying information. Further, in the buyer-end mobile device, the software program is executed to process the buying information (step S803 of FIG. 8) so as to extract features of the interested goods (step S805 of FIG. 8), and accordingly form one or more tags relating to the interested goods (step S807 of FIG. 8). The information including the one or more tags relating to the interested goods is uploaded to the trading server 52 (step S809 of FIG. 8). Further, the positioning or any input location information of the buyer 51 can also be uploaded to the trading server as well as uploading the buying information. It is noted that the location information can be inputted by the buyer 51 using an input module of the mobile device.

It is noted that, when the buying information is generated by the buyer-end device (the buyer 51), the instructions in the mobile device for trading the article further perform step of driving a GPS module of the mobile device to obtain location information associated with the mobile device, and transmit the location information to the trading server 52. After that, the trading server 52 receives the location information associated with the mobile device that is used to be one threshold for determining if there is a matched article.

After that, in the trading server 52, a matching process is performed to search the records in the database according to the tags submitted by the buyer-end device (step S811 of FIG. 8). In the matching process performed by the trading server 52, a matching policy is introduced. The matching policy is used to manage the thresholds for processing the matching based on the request made in the buyer information and the records in the database. In one embodiment, the matching policy includes setting a tag threshold of number of tags to determine if there is at least one matched article. In other words, the software-implemented function in the trading server 52 is used to search the records in the database by comparing the tags submitted by the buyer 51. The matching result is depending on how many tags are matched, and the threshold of number of tags set by the buyer 51 or the default value set by the default matching policy can restrict the result. The threshold with larger number of tags will find out more accurate articles concerning the interested goods, and vice versa.

In step 504 of FIG. 5, the trading server 52 generates an article list according to the matching result (step S813 of FIG. 8), and transmits the list to the buyer 51 (step S815 of FIG. 8). When the buyer 51 receives the article list, the buyer 51 can select one of the articles in the article list. Alternatively, the system allows the buyer 51 to abandon the list and repeat searching his interested goods. Such as step 505, the selection associated with a matched article and a matched seller (53) based on the article list made by the buyer 51 is transmitted to the trading server 52 (step S817 of FIG. 8).

When the trading server 52 receives the selection, as in step 506, an order is established by the data processing unit after confirming the order with the matched seller 53 in step 507. For completing the trading, the seller information is fed back to the buyer 51. In step 509, the trading server, according to one of the embodiments, may actively conduct a navigation route for both buyer 51 and the seller 53 (step S819 of FIG. 8). For example, the trading server 52 generates a navigation route for the matched seller 53 to be displayed on the seller 51's device and allows the seller 53 to deliver the matched article to the buyer 51. In another example, the navigation route may be provided to the buyer 51 to pick up the interested article as arriving the seller's location. Still further, the navigation route may be generated by the buyer 51 or the seller 53's device for reaching the matched article. While the matched article is successfully delivered, the trading is finished (step S821 of FIG. 8).

In addition, as well as the tags relating to the interested goods are submitted to the trading server for the matching policy, the location information associated with the mobile device of the buyer or the seller or both can be delivered to the trading server, and the trading server uses the location information as the reference to conduct the matching. That means, for forming the article list according to the matching policy when the trading server performs matching the tags with the records, the matching policy further includes setting a location threshold with a specific range of location to determine if there is at least one matched article. In other words, the software-implemented function in the trading server processes the matching not only based on the threshold of number of tags, but also involving the threshold of a range of location of the buyer or the seller.

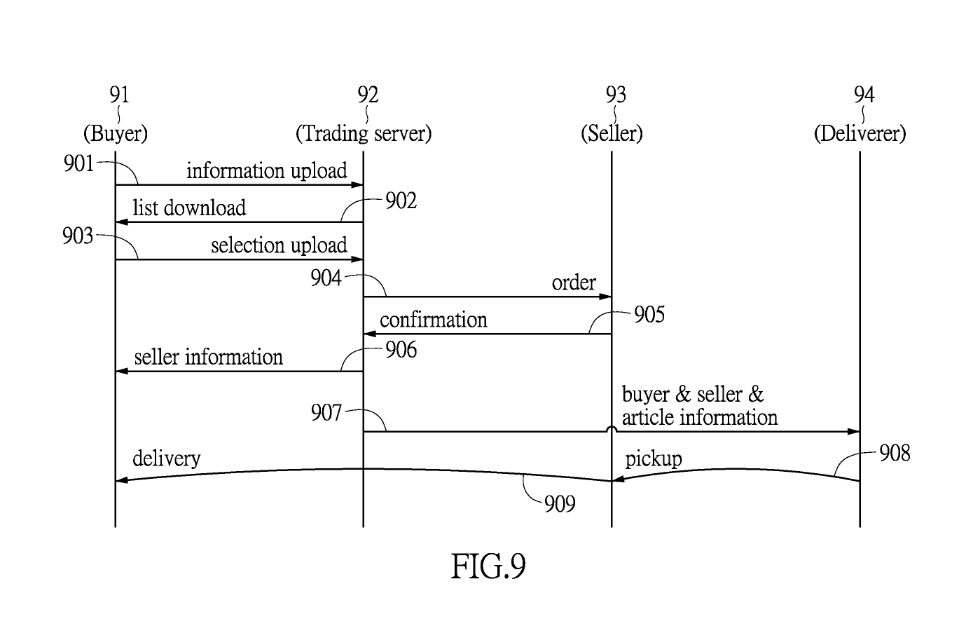

FIG. 9 shows one more flow chart illustrating a process to conduct trading between a buyer and a seller according to one further embodiment of the present invention. The flow chart shows the transaction process among the buyer 91, the trading server 92, the seller 93, and further a deliverer 94.

In step 901, when buying information including the information of interest goods generated by the buyer 91 is uploaded to trading server 92, the trading server 92 performs a matching process based on the tags relating to the interested goods and the records in the database of the trading server 92. The trading server 92 then generates an article list for the buyer 91, such as step 902. The article list may list a plurality of the articles based on the thresholds for matching such as the number of matching tags, and/or the threshold of range of location. The buyer 91 then selects at least one matched article, which is associated with at least one matched seller 93. The selection is uploaded of the trading server 92, such as in step 903. It is noted that the matched seller 93 may not be at fixed location, but in moving, therefore, the trading system allows the buyer 91 to complete the transaction instantly when the trading server 92 finds out a nearby matched seller.

In next step 904, the trading server 92 conducts an order with the matched seller 93 when the trading server 92 receives the selection made by the buyer 91. The seller 93 can confirm this order in step 905, or abandons the order. When the order is confirmed, the trading server 92 can transmit the both sides' information to both the buyer 91 and the seller 93, such as the seller information transmitted to the buyer 91 in step 906 for the buyer 91 to contact with the seller 93 or reach the seller 93. Both the buyer, seller, and the article information can be transmitted to the deliverer 94 according to the current embodiment, such as step 907. In this step 907, by the output unit of the trading server 92, both the location information associated with the buyer-end mobile device (91) and location of the seller 93 are transmitted to the deliverer 94 who is going to pick up the interested article from the matched seller 93 (step 908), and to deliver the matched article to the buyer 91 (step 909).

In addition, by the trading server 92, a navigation route can be formed and transmitted to the seller 93 according to the location information associated with the buyer-end mobile device (91) for conducting the delivery; or the navigation route based on both the location information associated with the buyer-end mobile device (91) and location of the seller 93 is transmitted to the deliverer 94.

Thus, the disclosure is related to establishing a system to conduct trading of an article between a buyer and a non-specified seller, and to a method thereof It is noted that not only the seller can be located in a fixed place, but the system also allows the seller to be any place when he is moving; therefore, the trading server of the present invention will conduct the matching process based on both the buyer's current location and the seller's instant location. While the articles registered in the trading server are associated with tags used to facilitate categorization, the software-implemented interface matches the tags with a plurality of records in a database of the trading server. The transaction between the buyer and the seller can be done when the buyer selects one matched article from the matching result made by the trading server, especially the result is based on the location information from both buyer and the seller, the trading server can provide navigation route for the further article delivery.

It is intended that the specification and depicted embodiment be considered exemplary only, with a true scope of the invention being determined by the broad meaning of the following claims.

What is claimed is:

1. A method, providing a trading server to conduct trading between a buyer and a seller, comprising:
in the trading server, receiving tags relating to an interested goods formed in a mobile device used by the buyer;
matching the tags with a plurality of records in a database of the trading server; wherein the records in the database are related to a plurality of tags related to a plurality of articles which are provided by at least one seller;
forming an article list according to a matching policy when the trading server performs matching the tags with the records;
transmitting the article list to the buyer;
receiving a selection based on the article list made by the buyer, wherein the selection is associated with a matched article and a matched seller;
in the trading server, establishing an order after confirming the order with the matched seller; and
informing the buyer, and then completing trading.

2. The method as recited in claim 1, wherein the mobile device of the buyer is installed with a software program which is used to form buying information made by the buyer.

3. The method as recited in claim 2, wherein, in the mobile device, the software program is used to process the buying information and extract features of the interested goods according to the buying information.

4. The method as recited in claim 3, wherein, in the mobile device, the software program is used to form the tags relating to the features of the interested goods, and transmit the tags to the trading server.

5. The method as recited in claim 4, wherein the matching policy includes setting a tag threshold of number of tags to determine if there is at least one matched article.

6. The method as recited in claim 2, wherein the software program drives a camera module of the mobile device to capture an image of the interested goods, and the software program performs an image processing upon the image and extracts features of the interest goods.

7. The method as recited in claim 1, wherein, as well as the tags relating to the interested goods, the trading server further receives location information associated with the mobile device.

8. The method as recited in claim 7, wherein, in the trading server, a navigation route is formed and transmitted to the seller according to the location information associated with the mobile device.

9. The method as recited in claim 8, wherein, in the trading server, both the location information associated with the mobile device and location of the seller are transmitted to a deliverer who is going to pick up the interested article from the seller, and to deliver the matched article to the buyer.

10. The method as recited in claim 7, wherein the location information is obtained by a GPS module of the mobile device.

11. The method as recited in claim 10, wherein, as well as matching the tags, the trading server further matches the location information with the plurality of records including location information related to the sellers in the database of the trading server.

12. The method as recited in claim 11, wherein the matching policy further includes setting a location threshold with a specific range of location to determine if there is at least one matched article.

13. The method as recited in claim 7, wherein the location information is inputted by the buyer using an input module of the mobile device.

14. A system for trading an article between a buyer and a seller, comprising:
a trading server, comprising:
a data receiving unit, used to receive buying information made by the buyer, including tags relating to an interested goods formed in a mobile device used by the buyer, and information of at least one seller and at least one article from every seller; wherein the data receiving unit is also used to receive a selection made by the buyer;
a data processing unit, used to process the information of the at least one seller and the at least one article for extracting features of the at least one article and forming one or more tags relating to every article; wherein the information of the at least one seller, the at least one article, and the one or more tags relating to every article are saved to a database;
a memory unit, used to save the buying information and the one or more tags relating the interested goods transmitted by the buyer;
a matching unit, used to retrieve the buying information and the one or more tags relating the interested goods from the memory unit, and match the tags with a plurality of records in the database of the trading server, so as to form an article list according to a matching policy; wherein the records in the database are related to the plurality of tags of the plurality of articles which are provided by the at least one seller;
an output unit, used to transmit the article list to the buyer;
a computer-readable storage device in the mobile device storing instructions for trading the article to perform steps comprising:
forming the buying information including the interested goods;
processing the buying information for extracting features of the interested goods;
forming one or more tags relating to the interested goods;
uploading the one or more tags to the trading server;
receiving the article list; and
transmitting the selection, made by the buyer, associated with a matched article and a matched seller based on the article list;
wherein, when the trading server receives the selection, an order is established by the data processing unit after confirming the order with the matched seller; and the trading is completed.

15. The system as recited in claim 14, wherein the matching policy includes setting a tag threshold of number of tags to determine if there is at least one matched article.

16. The system as recited in claim 14, wherein the matching policy further includes setting a location threshold with a specific range of location to determine if there is at least one matched article.

17. The system as recited in claim 14, wherein the instructions for trading the article perform steps further comprising:
drive a camera module of the mobile device to capture an image of the interested goods; and
performs an image processing upon the image and extracts features of the interest goods.

18. The system as recited in claim 17, wherein the instructions for trading the article perform steps further comprising:
drive a GPS module of the mobile device to obtain location information associated with the mobile device; and
transmit the location information to the trading server.

19. The system as recited in claim 18, wherein the trading server further receives the location information associated with the mobile device.

20. The system as recited in claim 19, wherein, by the output unit of the trading server, both the location information associated with the mobile device and location of the seller are transmitted to a deliverer who is going to pick up the interested article from the seller, and to deliver the matched article to the buyer.
